(19) United States
(12) Patent Application Publication
(10) Pub. No.: US 2021/0019791 A1
(43) Pub. Date: Jan. 21, 2021

(54) METHOD AND SYSTEM FOR ENHANCING RETAIL INTERACTION IN REAL-TIME

(71) Applicant: TOSHIBA TEC KABUSHIKI KAISHA, Tokyo (JP)

(72) Inventors: Kathiresan Selvaraj, Bangalore (IN); Rahul Gupta, Bangalore (IN)

(73) Assignee: TOSHIBA TEC KABUSHIKI KAISHA, Tokyo (JP)

(21) Appl. No.: 16/582,304

(22) Filed: Sep. 25, 2019

(30) Foreign Application Priority Data
Jul. 16, 2019 (IN) 201941028659

(51) Int. Cl. G06Q 30/02; G06F 16/23; G06N 20/00; G06Q 30/06

(52) U.S. Cl. CPC G06Q 30/0281; G06F 16/2379; G06Q 30/0613; G06N 20/00; G06Q 30/0282

(57) ABSTRACT

A method and a system are provided for enhancing retail interaction of a user in real-time. The system includes a processor and a memory configured to receive image frames of a user and environment around the user, track an interaction of the user with an item using the image frames, extract at least one of user characteristics or purchase preferences of the user from at least one of the image frames or a database, extract information about at least one of user action and at least one user facial micro-expression associated with the item from the image frames, determine a user reaction associated with the item based on the at least one user facial micro-expression, determine user-specific information based on at least one of the user characteristics, the purchase preferences, the user action or reaction, and provide the user-specific information to the user for enhancing retail interactions.

### TECHNICAL FIELD

The present subject matter is related in general to enhancing the retail interaction of a user in real-time, more particularly, but not exclusively, to a method and a system for enhancing the retail interaction of a user by evaluating a facial micro-expression of the user in real-time and presenting content accordingly.

### BACKGROUND

In retail business, personalization is key for retailers to connect with their customers. Personalization is about customers being recognized as individuals and treating them in a way that makes them feel unique and understood.

The challenge for retail business lies in replicating the kind of personalization that online platforms offer, at brick and mortar stores. With intense competition and new retailers seeking to increase their presence in already crowded retail market, retaining customers becomes a crucial part of the retail business. Having a right customer-specific personalization at brick and mortar stores can open plenty of opportunities for the retailers.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

In at least one embodiment, the present disclosure may relate to a method of assisting a user in real-time for enhancing retail interactions. The method includes receiving image frames of a user and environment around the user, tracking an interaction of the user with an item using the image frames, extracting at least one of user characteristics or purchase preferences of the user from at least one of the image frames and a database, extracting information about at least one of user action or user facial micro-expression associated with the item from the image frames, determining user reaction associated with the item based on the user facial micro-expression, determining user-specific information based on at least one of the user characteristics or the purchase preferences, the user action or the user reaction and providing the user-specific information to the user for enhancing retail interactions.

In at least one embodiment, the present disclosure may relate to an assistance system for enhancing retail interactions of a user in real-time. The system may include a processor and a memory communicatively coupled to the processor, wherein the memory stores processor-executable instructions, which on execution, may cause the processor to receive image frames of a user and environment around the user, track an interaction of the user with an item using the image frames, extract at least one of user characteristics or purchase preferences of the user from at least one of the image frames and a database, extract information about at least one of user action or user facial micro-expression associated with the item from the image frames, determine user reaction associated with the item based on the user facial micro-expression, determine user-specific information based on at least one of the user characteristics or the purchase preferences, the user action or the user reaction and provide the user-specific information to the user for enhancing retail interactions.

In at least one embodiment, the present disclosure may relate to a non-transitory computer readable medium including instructions stored thereon that when processed by at least one processor cause an assistance system to perform operations comprising receiving image frames of a user and environment around the user, tracking an interaction of the user with an item using the image frames, extracting at least one of user characteristics or purchase preferences of the user from at least one of the image frames and a database, extracting information about at least one of user action or user facial micro-expression associated with the item from the image frames, determining user reaction associated with the item based on the user facial micro-expression, determining user-specific information based on at least one of the user characteristics or the purchase preferences, the user action or the user reaction and providing the user-specific information to the user for enhancing retail interactions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

FIG. 1 illustrates an exemplary environment for assisting a user in real-time for enhancing retail interactions, in accordance with some embodiments of the present disclosure.

FIG. 2 shows a detailed block diagram of an assistance system, in accordance with some embodiments of the present disclosure.

FIG. 3a-FIG. 3b illustrate flowcharts showing a method of assisting a user in real-time for enhancing retail interactions, in accordance with some embodiments of the present disclosure.

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The terms “user”, “shopper”, “customer” or any other variations thereof may refer to a patron of a shop in the present application.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure relate to a method and a system for enhancing retail interaction of a shopper by evaluating facial micro-expression of the shopper in real-time and presenting content accordingly. A facial micro-expression may be an expression that appears on shopper's face according to his or her emotions while interacting with a product. Unlike regular, prolonged facial expressions, it is difficult to fake a brief involuntary facial micro-expression as facial micro-expressions occur as fast as 1/15 to 1/25 of a second. At least one embodiment of the present disclosure proposes a real-time personalized content that is deduced from shoppers' characteristics and preferences based on demographics, shopper's attire/outfit, item interaction history and shopper's current item interaction. Given that facial micro-expressions are universal across different people, and the face is known to be the best indicator of a person's emotion, capturing and analysing the shopper's facial micro-expression helps in identifying/gauging the exact emotions of the shopper. Consequently, at least one embodiment analyses the facial micro-expressions of the shopper to determine appropriate personalized marketing content, discounts or promotions.

The present disclosure providing personalized content to the shopper facilitates the shopper in making educated choices (e.g., more informed decisions) and reduces time required for making a decision on purchase of an item, thereby, enhancing shopper experience.

The present disclosure relates to a shopper or a user inside a store, e.g. a retail store or a brick and mortar store where the shopper can carry a shopping cart with display mounted on the shopping cart. Based on the disclosure described below, personalized content may be delivered to the shopper through the display mounted on the shopping cart. Additionally or alternatively, the personalized content may be delivered to the shopper through a store application on shopper's mobile phone while the shopper is inside the store.

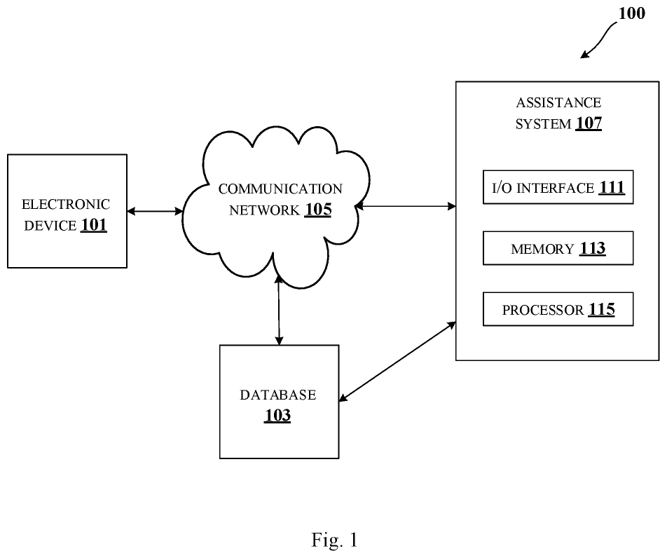

FIG. 1 illustrates an exemplary environment for assisting a user in real-time for enhancing retail interactions, in accordance with some embodiments of the present disclosure.

As shown in the FIG. 1, the environment 100 includes an electronic device 101, a database 103, a communication network 105 and an assistance system 107. The electronic device 101 may be connected through the communication network 105 to the assistance system 107. In at least one embodiment, the electronic device 101 may include, but is not limited to, a display device on shopping cart, a mobile terminal, a tablet computer, a display with a camera or a high-speed, high-resolution camera connected to the assistance system 107. A person skilled in the art would understand that, any electronic devices with a camera or just a camera, not mentioned explicitly, may also be used as the electronic device 101 in the present disclosure. The electronic device 101 may provide real-time input data to the assistance system 107 via the communication network 105 and may receive user-specific information based on the real-time input data from the assistance system 107 via the communication network 105. The real-time input data may be image frames including at least one of image or video of user. The communication network 105 may include, but is not limited to, a direct interconnection, an e-commerce network, a Peer-to-Peer (P2P) network, Local Area Network (LAN), Wide Area Network (WAN), wireless network (for example, using Wireless Application Protocol), Internet, Wi-Fi, Bluetooth and the like.

The assistance system 107 may provide user-specific information based on real-time input data of a user. The assistance system 107 may include an I/O interface 111, a memory 113 and a processor 115. The I/O interface 111 may be configured to receive the real-time input data from the electronic device 101. Analogously, the I/O interface 111 may be configured to provide the user-specific information to the electronic device 101. Here, the user-specific information may include at least one of item information or information of one or more similar items. The item information may include personalized marketing content, discounts, promotions, sales promotion content, upsell and cross-sell information related to the particular item. The I/O interface 111 may employ communication protocols/methods such as, without limitation, audio, analog, digital, monoaural, Radio Corporation of America (RCA) connector, stereo, IEEE-1394 high speed serial bus, serial bus, Universal serial bus (USB), infrared, Personal system/2 (PS/2) port, Bayonet Neill-Concelman (BNC) connector, coaxial, component, composite, Digital visual interface (DVI), High-definition multimedia interface (HDMI), Radio frequency (RF) antennas, S-Video, Video graphics array (VGA), IEEE 802.11b/g/n/x, Bluetooth, cellular (e.g., Code-division multiple access (CDMA), High-speed packet access (HSPA+), Global system for mobile communications (GSM), Long-term evolution (LTE), Worldwide interoperability for microwave access (WiMax), or the like, etc.

The real-time input data received by the I/O interface 111 and the user-specific information to be provided through the I/O interface 111 may be stored in the memory 113. The memory 113 may be communicatively coupled to the processor 115 of the assistance system 107. The memory 113, which may be a non-transitory memory, may store processor instructions (e.g., executable instructions) which may cause the processor 115 to execute the instructions for providing the user-specific information. The memory 113 may include, without limitation, memory drives, removable disc drives, etc. The memory drives may further include a drum, magnetic disc drive, magneto-optical drive, optical drive, Redundant Array of Independent Discs (RAID), solid-state memory devices, solid-state drives, etc.

The processor 115 may include at least one data processor for providing the user-specific information. The processor 115 may include specialized processing units such as integrated system (bus) controllers, memory management control units, floating point units, graphics processing units, digital signal processing units, etc.

In at least one embodiment, the assistance system 107 may exchange data with a database 103 directly or through the communication network 105. The database 103 may be populated or stored with the data that includes at least one of user-specific information, user actions, user characteristics, user inputs and purchase preferences of a user under respective user profile. Here, the user-specific information may comprise at least one of item information or information of one or more similar items. The item information may include personalized marketing content, discounts, promotions, sales promotion content, upsell and cross-sell information related to the particular item based on adaptive learning/training from an adaptive learning module (described below in detail) that may be stored in the database 103. The user characteristics may comprise at least one of user demographics, user outfit and user accessories and the purchase preferences may comprise item interaction history of retail interactions. In addition to the item interaction history, the purchase preferences may include other information related to the interacted item such as price of item, brand of item, size of item, etc. The database 103 may be used to store the real-time input data, which may be image frames including at least one of image and video of a user and environment around the user. Here, the environment around the user may refer to the setting or arrangements behind or around the user in a store. For instance, when a user is walking in a store or stopping to look at a particular item in the store, aisles with items/products behind or around the user may, also, be considered when an image or a video of the user is considered.

The database 103 may, also, be updated at pre-defined intervals of time or real-time. These updates may be related to at least one of the user-specific information, the user action, the user characteristics, the user input and the purchase preferences of the user. These updates may be used for adaptive learning purpose.

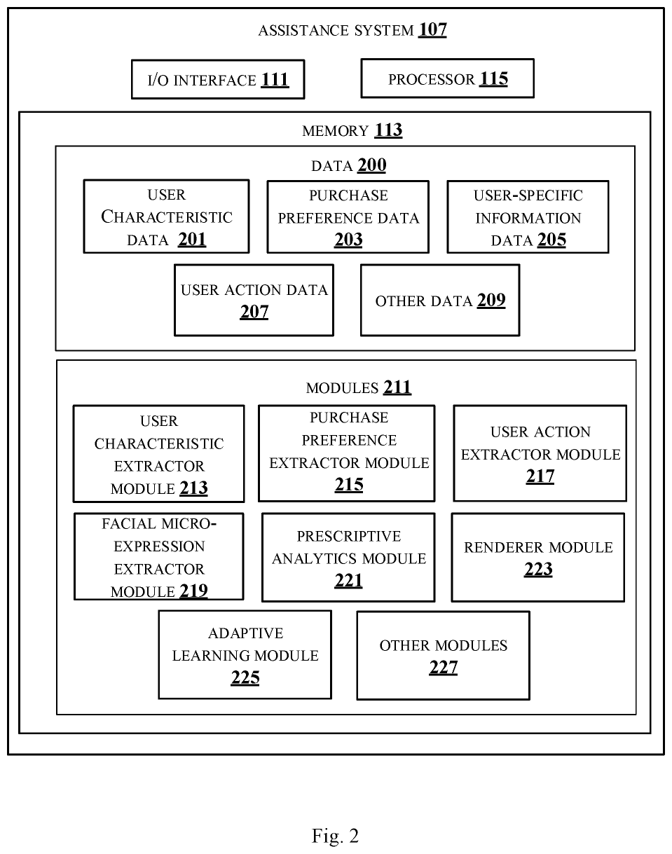

FIG. 2 shows a detailed block diagram of an assistance system, in accordance with some embodiments of the present disclosure.

The assistance system 107, in addition to the I/O interface 111 and processor 115 described above, may include data 200 and one or more modules 211, which are described herein in detail. In at least one embodiment, data 200 may be stored within the memory 113. The data 200 may include, for example, user characteristic data 201, purchase preference data 203, user-specific information data 205, user action data 207 and other data 209.

The user characteristic data 201 may include, but is not limited to, information about at least one of user demographics, user outfit and user accessories. Here, the user demography may include age, gender, race, ethnicity, etc. of the user. The user outfit may include clothing worn by the user that may include brand of clothes, type of clothes such as jeans, T-shirts, etc. The user accessories may include clothing accessories, ornaments, etc. that may be worn to complement the user outfit.

The purchase preference data 203 may include, but not limited to, item interaction history of retail interactions of a user. The item interaction history may include the user's interaction with one or more items/products in past or the user's interaction with one or more items/products in present when the user is shopping for products.

The user-specific information data 205 may include at least one of item information and information of one or more similar items specific to each user. Here, the item information may include personalized marketing content, discounts, promotions, sales promotion content, upsell and cross-sell information related to the particular item. The information of one or more similar items may include the above-mentioned item information about the other items that are similar to the item that the user has decided not to buy after looking at the item.

The user action data 207 may include information related to actions involved or performed by a user when looking at an item. For instance, the user may flip the item to check the price of the item at first, followed by ingredients mentioned on the item, then company name, etc. These actions performed by the user are stored as action data.

The other data 207 may store data, including temporary data and temporary files, generated by modules 211 for performing the various functions of the assistance system 107.

In at least one embodiment, the data 200 in the memory 113 are processed by the one or more modules 211 present within the memory 113 of the assistance system 107. The one or more modules 211 may be implemented as dedicated hardware units. As used herein, the term module refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality. In some implementations, the one or more modules 211 may be communicatively coupled to the processor 115 for performing one or more functions of the assistance system 107. The said modules 211 when configured with the functionality defined in the present disclosure will result in a novel hardware.

In one implementation, the one or more modules 211 may include, but are not limited to, a user characteristic extractor module 213, a purchase preference extractor module 215, a user action extractor module 217, a facial micro-expression extractor module 219, a prescriptive analytics module 221, a renderer module 223 and an adaptive learning module 225. The one or more modules 211 may, also, include other modules 227 to perform various miscellaneous functionalities of the assistance system 107.

The user characteristic extractor module 213 may receive real-time input data that may include image frames of a user and environment around the user. The image frames may be at least one of image and video. For instance, when a user or a shopper walks into a store, his/her real-time video or image is received by the user characteristic extractor module 213 of the assistance system 107. The received image frames may be analysed by the user characteristic extractor module 213 for extracting information about at least one of user demographics, user outfit and user accessories. The extracted user characteristic information may be stored in the user characteristic data 201. The user characteristic extractor module 213 may receive the at least one of image and video through the I/O interface 111. The extracted user characteristic information may be fed to the prescriptive analytics module 221 for further analyses and to the database 103 to be stored under a specific user profile.

The purchase preference extractor module 215 may, also, receive real-time input data that may include image frames of a user and environment around the user. The image frames may be at least one of image and video. The received image frames may be analysed by the purchase preference extractor module 215 for extracting information about item interaction details of retail interactions of the user in real-time. The purchase preference extractor module 215 may, also, analyse data received from the purchase preference data 203 on the item interaction history that may include the user's interaction with one or more items/products in past. For instance, a user in a store may pick an item or a product, look at the item for its details and later he/she may or may not buy the product. This information may be stored in the database 103 and the purchase preference data 203 as user's past item interaction. The item interaction history may include the user's interaction with one or more items/products in past or the user's interaction with one or more items/products in present when the user is shopping for products.

The purchase preference extractor module 215 may extract the user's interaction with one or more products in present when the user is shopping for products and may be fed to the prescriptive analytics module 221 for further analyses and to the database 103 to be stored under the specific user profile. The purchase preference extractor module 215 may receive the at least one of image and video through the I/O interface 111. Furthermore, the extracted purchase preference information may be stored in the purchase preference data 203.

The user action extractor module 217 may, also, receive real-time input data that may include image frames of a user and environment around the user. The received image frames may be analysed by the user action extractor module 217 for extracting information related to actions involved or performed by a user when looking at an item. These actions performed by the user are stored as information in the user action data 207. The user action extractor module 217 may feed the extracted data to the prescriptive analytics module 221 for further analyses and also to the database 103 to be stored under the specific user profile. The user action extractor module 217 may receive the at least one of image and video through the I/O interface 111.

The facial micro-expression extractor module 219 may receive real-time input data that may include image frames of a user and environment around the user. The received image frames may be analysed by the facial micro-expression extractor module 219 for extracting information related to user's facial micro-expressions. Typical facial micro-expressions may include disgust, anger, fear, sadness, happiness, surprise and contempt. For extracting facial micro-expressions of the user, technologies involving, but not limited to, high-speed video system for micro-expression detection and recognition techniques, machine vision algorithm to recognize hidden facial expressions, video analytics and spontaneous micro-expression spotting and recognition methods may be used. A person skilled in the art would understand that any other technique for detecting micro-expression may be used in the present disclosure. The facial micro-expression extractor module 219 may feed the extracted data to the prescriptive analytics module 221 for further analyses and also, to the database 103 to be stored under the specific user profile. The facial micro-expression extractor module 219 may receive the at least one of image and video through the I/O interface 111.

The prescriptive analytics module 221 may receive inputs from the user characteristic extractor module 213, the purchase preference extractor module 215, the user action extractor module 217 and the facial micro-expression extractor module 219. These inputs may be analysed by the prescriptive analytics module 221 using video analytical tools and algorithms to predict user emotion/reaction. Based on the predicted user reaction along with at least one of the user characteristics and the purchase preferences and the user action from the respective modules, information related to promotion of particular item, cross-sell/upsell, particular item information, comparisons between similar items, etc. may be fetched by the prescriptive analytics module 221 from the database 103 and sent to the renderer module 223 and the adaptive learning module 225.

The renderer module 223 may receive the information related to promotion of item, cross-sell/upsell, item information, comparisons between similar items, etc. from the prescriptive analytics module 221. The received information may be rendered to the electronic device 101 through the I/O interface 111. The reaction of the user to the received information may be fed back through the I/O interface 111 to the at least one of the user characteristic extractor module 213, the purchase preference extractor module 215, the user action extractor module 217, the facial micro-expression extractor module 219, the prescriptive analytics module 221 and the adaptive learning module 225 for extracting respective information and for further analyses.

The adaptive learning module 225 may receive the reaction of the user to the received information from the renderer module 223 through the I/O interface 111 as an input. This input may be analysed using machine learning algorithm along with the information related to promotion of item, cross-sell/upsell information, item information, comparisons between similar items, predefined discounts, etc. that was sent to the renderer module 223. The output of adaptive learning module 225 may be fed to the prescriptive analytics module 221 for self-learning and improving the accuracy of prediction of the prescriptive analytics module 221.

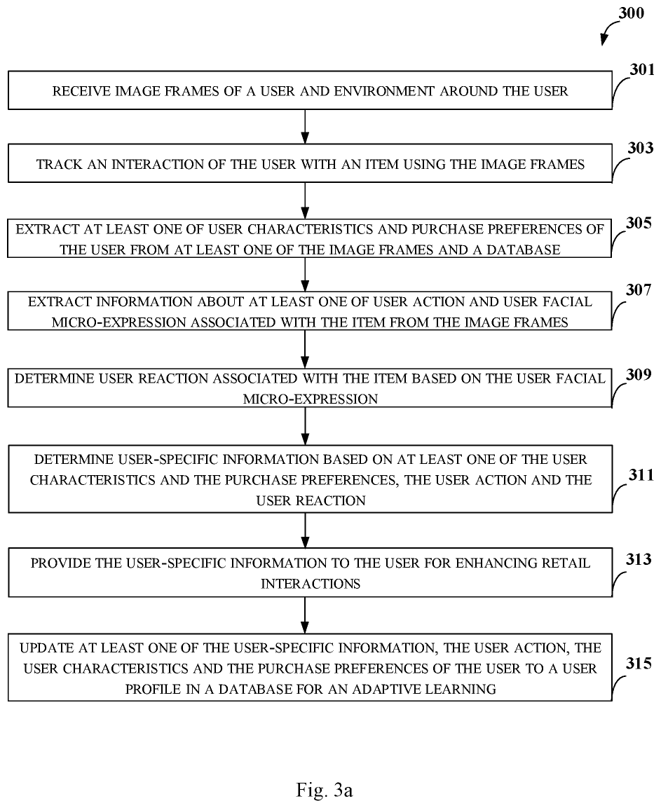

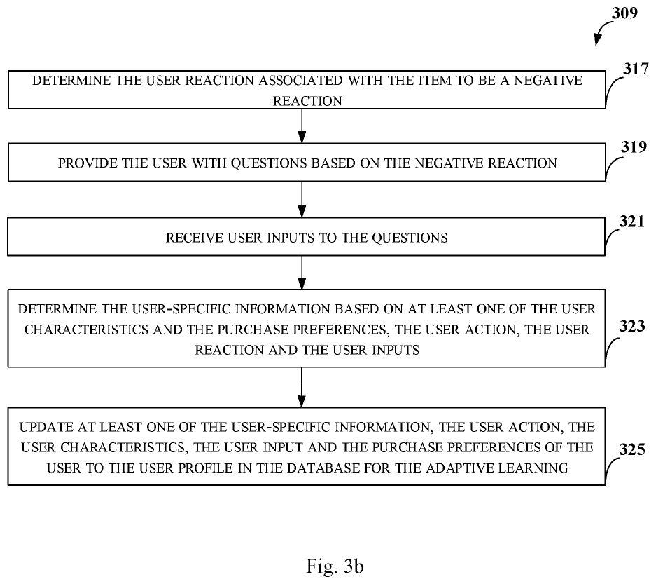

FIG. 3a-FIG. 3b illustrate flowcharts showing a method of assisting a user in real-time for enhancing retail interactions, in accordance with some embodiments of the present disclosure.

In FIG. 3a, based on real-time input data, the user is presented with information. In FIG. 3b, if the user's reaction to the presented information described in the FIG. 3a happens to be negative, the user is presented with new information accordingly.

As illustrated in FIG. 3a-FIG. 3b, the method 300 includes one or more blocks for assisting a user in real-time for enhancing retail interactions. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the assistance system 107 may receive the real-time input data from the electronic device 101via the I/O interface 111. Here, the real-time input data may be image frames including at least one of image or video of the shopper, or image or video of the environment around the user/shopper. Hereinafter, the terms “user” and “shopper” may be interchangeably used. For instance, when a shopper walks to a store for shopping, as soon as the shopper enters the store, high-speed, high-resolution cameras configured in the store or display attached to a shopping cart that the shopper carries may capture the shopper's images and send them to the assistance system 107. In brief, at block 301, image frames of a user and environment around the user may be received.

At block 303, the purchase preference extractor module 215 may receive the real-time input data from the electronic device 101. The purchase preference extractor module 215 may dynamically track user's item interaction history. For instance, when the shopper starts shopping and walks through aisles inside a shop, picking items of interest, high-speed and high-resolution cameras installed in the store capture the images and feed them to the respective modules to analyse shopper's item interaction. At this stage, the user may continue to look around for the items of interest. In brief, at block 303, using the image frames of the user's interaction with an item may be tracked.

At block 305, the user characteristic extractor module 213 may receive the real-time input data from the electronic device 101 for deducing information about at least one of user demographics, one or more user outfits or one or more user accessories. For instance, when a shopper enters a store or walking around in the store, high-speed/resolution cameras installed at the store capture the shopper's image and feed the image to the user characteristic extractor module 213 to perform demographic analysis i.e., deducing the age, gender, race, ethnicity etc. and also, to analyse the shopper's characteristic based on the shopper's attire and outfits. Furthermore, at block 305, the purchase preference extractor module 215 may, also, extract the user's purchase preferences. In brief, at block 305, at least one of user characteristics and purchase preferences of the user may be extracted from at least one of the image frames and a database (103).

At blocks 307, the user action extractor module 217 and the facial micro-expression extractor module 219 may receive the real-time image frames from the electronic device 101 via the I/O interface 111. The facial micro-expression extractor module 219 may extract facial micro-expressions of the user when the user interacts with items, and the user action extractor module 217 may extract corresponding user action. Here, the user action may include the actions involved or performed by the user when looking at an item. For instance, as the shopper shops, he/she stops at an aisle examining a product for a duration longer than required for picking, checking and adding an item to a shopping cart, the user action extractor module 217 and the facial micro-expression extractor module 219 may receive the real-time image frames data from the cameras in the store.

In brief, at block 307, information about at least one of user action and user facial micro-expression associated with the item may be extracted from the image frames.

At block 309, the facial micro-expression extractor module 219 may extract user reaction based on the input received in the block 307. The facial micro-expression extractor module 219 may map the shopper's facial micro-expression with seven universal micro-expressions to understand the shopper's emotion towards the product. Here, the seven universal micro-expressions may include disgust, anger, fear, sadness, happiness/happy, surprise and contempt. In brief, at block 309, user reaction associated with the item based on the user facial micro-expression may be determined.

At block 311, based on the extracted information from the user characteristic extractor module 213, the purchase preference extractor module 215, the user action extractor module 217 and the facial micro-expression extractor module 219, the prescriptive analytics module 221 may determine user-specific information that may include personalized marketing content, discounts, promotions, sales promotion content, upsell and cross-sell information related to the particular item. The required user-specific information may be fetched from the database 103 by the prescriptive analytics module 221 and fed to the renderer module 223. In brief, at block 311, user-specific information based on at least one of the user characteristics and the purchase preferences, the user action and the user reaction may be determined.

Below are the few examples with reference to user's facial micro-expression and corresponding analytical output of the prescriptive analytics module 221.

Example 1: if the shopper's initial facial micro-expression towards the product is “happy,” but when the shopper turns to side where the price is printed and shopper's facial micro-expression changes to “sadness,” the prescriptive analytics module 221 determines that the shopper is willing to buy the product but not happy with the price. In this case, the prescriptive analytics module 221 analyses the change in reaction/emotion to come up with a suitable personalized promotion/discount and push the suitable personalized promotion/discount to the shopper to tip him/her to make a purchase.

Example 2: if the shopper's facial micro-expression turns to “surprise” after looking at the price, the prescriptive analytics module 221 determines that the shopper likes the product and is contemplating whether to make a purchase. In this case, the prescriptive analytics module 221 pushes for an appropriate product information and a suitable comparison data to convert the shopper's interest into a purchase.

Example 3: If the shopper's initial facial micro-expression towards the product is “happy”, but when the shopper turns the side where product information is printed, shopper's facial micro-expression changes to “disgust”/“sadness”, the prescriptive analytics module 221 determines that the shopper's emotion towards the product changed after looking at the ingredient or product information and suggests a suitable alternative considering the change in reaction/emotion.

Example 4: in case of an another scenario, where the shopper purchased an expensive dress/item and trying to find an accompanying item, depending on the item shopper is looking at and based on shopper's facial micro-expression, the prescriptive analytics module 221 deduces that the shopper is looking for a suitable item in conjunction with the primary product already purchased. The prescriptive analytics module 221, in this case, pushes suitable cross-sell suggestions matching the shopper's demographics/characteristics.

At block 313, the renderer module 223 may receive the user-specific information from the prescriptive analytics module 221 and render the user-specific information to the electronic device 101, which may be a display attached to a shopping cart or a user mobile, via the I/O interface 111. In brief, at block 313, the user-specific information to the user may be provided for enhancing retail interactions.

At block 315, the assistance system 107 may update at least one of the user-specific information, the user action, the user characteristics and the purchase preferences of the user extracted in the blocks 301 to 311 to a user profile in the database 103. Furthermore, the information such as whether the user-specific information resulted in a sale of the item or not may also be recorded by the assistance system 107 and fed to the adaptive learning module 225 for learning and fine-tuning the user-specific information including related marketing content, promotions, discounts and upsell/cross-sell suggestions. In brief, at block 315, at least one of the user-specific information, the user action, the user characteristics and the purchase preferences of the user may be updated to a user profile in the database (103) for an adaptive learning.

FIG. 3b illustrates flowchart showing a method of assisting a user in real-time for enhancing retail interactions, when the user's reaction to the presented information described in the FIG. 3a happens to be negative, in accordance with some embodiments of the present disclosure.

At block 317, the facial micro-expression extractor module 219 may extract user reaction based on the input received in the block 307. The facial micro-expression extractor module 219 may map the shopper's facial micro-expression with the seven universal micro-expressions to understand the shopper's emotion towards the product. Here the facial micro-expression extractor module 219 may detect the user's facial micro-expressions to be negative (e.g., disgust, anger, fear, sadness) to determine that the user is no longer interested in the item or does not like the item. In brief, at block 317, the user reaction associated with the item to be a negative reaction may be determined.

At block 319, the user may be provided with questions through the electronic device 101 based on the negative reaction that was received in block 317. Here, the user may be prompted with simple questions to precisely understand the user's need such that a tailor-made personalization specific to the user can be determined. The question may include what sort of product the user might be interested, what price range, which brand, etc. In brief, at block 319, the user may be provided with questions based on the negative reaction.

At block 321, the user input to the questions presented in block 319 may be recorded through the electronic device 101 and sent to the prescriptive analytics module 221 for analysis. In brief, at block 321, user inputs to the questions may be received.

At block 323, based on the user input to the questions along with the extracted information from the user characteristic extractor module 213, the purchase preference extractor module 215, the user action extractor module 217 and the facial micro-expression extractor module 219, the prescriptive analytics module 221 may determine user-specific information that may include updated personalized marketing content, discounts or promotions. The updated user-specific information may be fetched from the database 103 by the prescriptive analytics module 221 and fed to the renderer module 223 to be sent to the electronic device 101 via the I/O interface 111. In brief, at block 323, the user-specific information based on at least one of the user characteristics and the purchase preferences, the user action, the user reaction and the user inputs may be determined.

At block 325, the assistance system 107 may update at least one of the user-specific information, the user action, the user characteristics, the purchase preferences and the user input of the user extracted in the blocks 301 to 309 and in blocks 317 to 323 to the user profile in the database 103 for an adaptive learning. Furthermore, the information such as whether the user-specific information resulted in a sale of the item or not may, also, be recorded by the assistance system 107 and fed to the adaptive learning module 225 for learning and further fine-tuning the user-specific information. In brief, at block 325, at least one of the user-specific information, the user action, the user characteristics, the user input and the purchase preferences of the user may be updated to the user profile in the database (103) for the adaptive learning.

At least one embodiment of the present disclosure allows the shopper/user to make an educated choice, thereby, enhancing their shopping experience. For instance, shopper does not have to spend a lot of time to decide whether to buy or not to buy a product.

At least one embodiment of the present disclosure facilitates personalization in retail stores, thereby, helping shoppers to experience the same kind of personalization that online platforms would offer at the retail stores.

At least one embodiment of the present disclosure uses facial micro-expression for reading user emotions. The chances of faking expressions, especially, facial micro-expressions are low or impossible and hence, user gets personalized service during their shopping/at the moment of truth and not at the time of checkout or post checkout. This helps the user to make appropriate decisions.

### Computing System

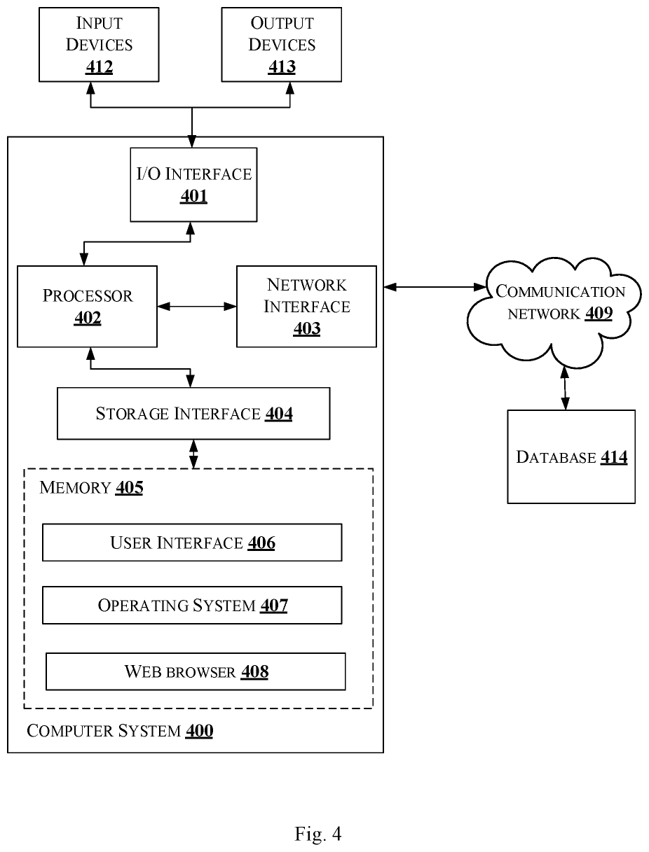

FIG. 4 illustrates a block diagram of an exemplary computer system 400 for implementing embodiments consistent with the present disclosure. In at least one embodiment, the computer system 400 may be used to implement the assistance system 107. The computer system 400 may include a central processing unit (“CPU” or “processor”) 402. The processor 402 may include at least one data processor for assisting a user in real-time for enhancing retail interactions. The processor 402 may include specialized processing units such as, integrated system (bus) controllers, memory management control units, floating point units, graphics processing units, digital signal processing units, etc.

The processor 402 may be disposed in communication with one or more input/output (I/O) devices via I/O interface 401. The I/O interface 401 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the computer system 400 may communicate with one or more I/O devices such as input devices 412 and output devices 413. For example, the input devices 412 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 413 may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

In some embodiments, the computer system 400 consists of the assistance system 107. The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission control protocol/internet protocol (TCP/IP), token ring, IEEE 802.11a/b/g/n/x, etc. The communication network 409 may include, without limitation, a direct interconnection, Local area network (LAN), Wide area network (WAN), wireless network (e.g., using Wireless Application Protocol), the Internet, etc. Using the network interface 403 and the communication network 409, the computer system 400 may communicate with a database 414. The network interface 403 may employ connection protocols include, but not limited to, direct connect, Ethernet (e.g., twisted pair 10/100/1000 Base T), Transmission control protocol/internet protocol (TCP/IP), token ring, IEEE 802.11a/b/g/n/x, etc.

The communication network 409 includes, but is not limited to, a direct interconnection, an e-commerce network, a peer to peer (P2P) network, Local area network (LAN), Wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext transfer protocol (HTTP), Transmission control protocol/internet protocol (TCP/IP), Wireless application protocol (WAP), etc., to communicate with each other. Further, the first network and the second network may include a variety of network devices, including routers, bridges, servers, computing devices, storage devices, etc.

In some embodiments, the processor 402 may be disposed in communication with a memory 405 (e.g., RAM, ROM, etc. not shown in the figures) via a storage interface 404. The storage interface 404 may connect to memory 405 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407 etc. In some embodiments, computer system 400 may store user/application data, such as, the data, variables, records, etc., as described in this disclosure. Such databases may be implemented as fault-tolerant, relational, scalable, secure databases such as Oracle or Sybase.

The operating system 407 may facilitate resource management and operation of the computer system 400. Examples of operating systems 407 include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBMTM OS/2, MICROSOFT™ WINDOWS™ (XP™, VISTA™/7/8, 10 etc.), APPLER IOS™, GOOGLE® ANDROID™, BLACKBERRY® OS, or the like.

In some embodiments, the computer system 400 may implement a web browser 408 stored program component. The web browser 408 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX™, DHTML™, ADOBE® FLASH™, JAVASCRIPT™, JAVA™, Application Programming Interfaces (APIs), etc. In some embodiments, the computer system 400 may implement a mail server (not shown in the figures) stored program component. The mail server may be an Internet mail server such as Microsoft Exchange, or the like. The mail server may utilize facilities such as ASP™, ACTIVEX™, ANSI™ C++/C#, MICROSOFT®, NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client (not shown in the figures) stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

At least one embodiment of the present disclosure renders personalized content based on facial micro-expression of a user, thereby enhancing the user's retail interaction particularly at brick and mortar stores.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself

The illustrated operations of FIGS. 3a and 3b show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

REFERRAL NUMERALS:

| Reference number | Description |
|---|---|
| 100 | Environment |
| 101 | Electronic device |
| 103 | Database |
| 105 | Communication network |
| 107 | Assistance system |
| 111 | I/O interface |
| 113 | Memory |
| 115 | Processor |
| 200 | Data |
| 201 | User characteristic data |
| 203 | Purchase preference data |
| 205 | User-specific information data |
| 207 | User action data |
| 209 | Other data |
| 211 | Modules |
| 213 | User characteristic extractor |
| | module |
| 215 | Purchase preference extractor |
| | module |
| 217 | User action extractor module |
| 219 | Facial micro-expression |
| | extractor module |
| 221 | Perspective analytics module |
| 223 | Renderer module |
| 225 | Adaptive learning module |
| 227 | Other modules |
| 400 | Computer system |
| 401 | I/O interface |
| 402 | Processor |
| 403 | Network interface |
| 404 | Storage interface |
| 405 | Memory |
| 406 | User interface |
| 407 | Operating system |
| 408 | Web browser |
| 409 | Communication network |
| 412 | Input devices |
| 413 | Output devices |
| 414 | Database |

We claim:

1. A method of assisting a user in real-time for enhancing retail interactions, the method comprising:
receiving, by an assistance system, respective image frames of a user and an environment around the user;
tracking, by the assistance system, an interaction of the user with an item using the image frames;
extracting, by the assistance system, at least one of user characteristics or purchase preferences of the user from at least one of the image frames or a database;
extracting, by the assistance system, information based on the image frames about at least one of user action or at least one user facial micro-expression associated with the interaction of the user with the item;
determining, by the assistance system, a user reaction associated with the item based on the at least one user facial micro-expression;
determining, by the assistance system, user-specific information based on at least one of the user characteristics, the purchase preferences, the user action, or the user reaction; and
providing, by the assistance system, the user-specific information to the user for enhancing the interaction.

2. The method of claim 1, further comprising:
updating, by the assistance system, at least one of the user-specific information, the user action, the user characteristics or the purchase preferences of the user to a user profile in the database for adaptive learning.

3. The method of claim 1, further comprising:
determining, by the assistance system, the user reaction associated with the item to be a negative reaction;
providing, by the assistance system, the user with questions based on the negative reaction;
receiving, by the assistance system, user inputs to the questions; and
determining, by the assistance system, the user-specific information based on at least one of the user characteristics, the purchase preferences, the user action, the user reaction or the user inputs.

4. The method of claim 3, further comprising:
updating, by the assistance system, at least one of the user-specific information, the user action, the user characteristics, the user input or the purchase preferences of the user to the user profile in the database for the adaptive learning.

5. The method of claim 1, wherein the user characteristics comprise at least one of user demographics, a user outfit or user accessory, and wherein the purchase preferences comprise an item interaction history of retail interactions.

6. The method of claim 1, wherein the user-specific information comprises at least one of item information or information of one or more similar items.

7. The method as claimed in claim 1, wherein the at least one user facial micro-expression comprises one of disgust, anger, fear, sadness, happiness, surprise or contempt.

8. An assistance system for enhancing retail interactions of a user in real-time, the system comprising:
a processor; and
a memory communicatively coupled to the processor, wherein the memory stores processor-executable instructions, which on execution, cause the processor to:
receive respective image frames of a user and an environment around the user;
track an interaction of the user with an item using the image frames;
extract at least one of user characteristics or purchase preferences of the user from at least one of the image frames or a database;
extract information about at least one of a user action or at least one user facial micro-expression associated with the interaction of the user with the item from the image frames;
determine a user reaction associated with the item based on the at least one user facial micro-expression;
determine user-specific information based on at least one of the user characteristics, the purchase preferences, the user action, or the user reaction; and
provide the user-specific information to the user for enhancing the interaction.

9. The assistance system of claim 8, wherein the processor is further configured to:
update at least one of the user-specific information, the user action, the user characteristics or the purchase preferences of the user to a user profile in the database for adaptive learning.

10. The assistance system of claim 8, wherein the processor is further configured to:
determine the user reaction associated with the item to be a negative reaction;
provide the user with questions based on the negative reaction;
receive user inputs to the questions; and
determine the user-specific information based on at least one of the user characteristics, the purchase preferences, the user action, the user reaction, or the user inputs.

11. The assistance system of claim 10, wherein the processor is further configured to:
update at least one of the user-specific information, the user action, the user characteristics, the user input or the purchase preferences of the user to the user profile in the database for the adaptive learning.

12. The assistance system of claim 8, wherein the user characteristics comprises at least one of user demographics, a user outfit, or a user accessory, and wherein the purchase preferences comprises item interaction history of retail interactions.

13. The assistance system of claim 8, wherein the user-specific information comprises at least one of item information or information of one or more similar items.

14. The assistance system of claim 8, wherein the at least one user facial micro-expression comprises one of disgust, anger, fear, sadness, happiness, surprise or contempt.

15. A non-transitory computer readable medium including instructions stored thereon that when processed by at least one processor cause an assistance system to perform operations comprising:
receiving respective image frames of a user and an environment around the user;
tracking an interaction of the user with an item using the image frames;
extracting at least one of user characteristics or purchase preferences of the user from at least one of the image frames or a database;
extracting information about at least one of user action or at least one user facial micro-expression associated with the interaction of the user with the item from the image frames;
determining a user reaction associated with the item based on the at least one user facial micro-expression;
determining user-specific information based on at least one of the user characteristics, the purchase preferences, the user action, or the user reaction; and
providing the user-specific information to the user for enhancing retail interactions.
